(19) United States
(12) Patent Application Publication
(10) Pub. No.: US 2016/0315990 A1
(43) Pub. Date: Oct. 27, 2016

(54) ELECTRONIC DEVICE, BROADCASTING SERVER AND METHOD FOR MANAGING DISPLAYING AND BROADCASTING OF MULTIMEDIA CONTENT

(71) Applicant: Wipro Limited, Bangalore (IN)

(72) Inventor: Santhosh Kumar Mohan Naidu, Bangalore (IN)

(21) Appl. No.: 14/750,582

(22) Filed: Jun. 25, 2015

(30) Foreign Application Priority Data
Apr. 23, 2015 (IN) 2078/CHE/2015

(51) Int. Cl. H04L 29/06

(52) U.S. Cl. CPC H04L 65/604; H04L 65/4076

(57) ABSTRACT

A method for managing displaying of multimedia content on an electronic device includes receiving multimedia stream from a broadcasting server by the electronic device. One of splice information associated with the multimedia stream or Group of Pictures (GOP) frame sequence of the multimedia stream is identified. Current slot information of the multimedia content to be broadcasted from one of the splice information or the GOP frame sequence is determined. The current slot information of the multimedia content is modified based on one or more decision parameters associated with the multimedia content. The multimedia content is displayed based on the modified current slot information for managing the displaying of the multimedia content on the electronic device.

This application claims the benefit of Indian Application Serial No. 2078/CHE/2015 filed Apr. 23, 2015, which is hereby incorporated by reference in its entirety.

### FIELD

The present subject matter is related, in general to multimedia technologies and more particularly, but not exclusively to a broadcasting server for managing broadcasting of multimedia content to an electronic device, an electronic device for displaying multimedia content on the electronic device and method thereof.

### BACKGROUND

A user watches one or more multimedia streams which include, without limitations, videos, moving visuals, pictures, films, flicks, movies, cinemas, serials, soaps, shows, images and other entertainment streams. The one or more multimedia streams are displayed on an electronic device which includes, without limitations, mobile phone, television, computer, laptop, tablet, smartphone, and the like. In general, one or more advertisement slots are inserted into the one or more multimedia streams while broadcasting the one or more multimedia streams to the electronic device. For example, each hour of video broadcasted could contain 16 minutes of advertisement slots to play the advertisements totally for 16 minutes slots wise in each hour of video.

FIG. 1 a shows traditional advertisement system 100 to play advertisements. The traditional advertisement system 100 includes a multimedia broadcasting system 102, an advertisement targeting system 104 and an electronic device 106, for example a television. The multimedia broadcasting system 102 is associated to a channel vendor who broadcasts the one or more multimedia streams. For example, consider the multimedia broadcasting system 102 owns a ‘XYZ’ channel who broadcasts one or more videos on the ‘XYZ’ channel. Each video is defined to be one hour duration on the ‘XYZ’ channel. While broadcasting each video, advertisement slots can be inserted into each video for playing the advertisements. The advertisement slots insertion is carried out based on business rules and regulations which are predefined for the video on the ‘XYZ’ channel. The business rules and regulations include, without limitations, size of the advertisement slots, and position of the advertisement slots in the video etc. The business rules and regulations may be predefined by the multimedia broadcaster/operator (not shown) and/or an advertisement broadcaster/operator (not shown) who configure broadcasting or insertion of the advertisement slots in the multimedia stream. After the advertisement slots are inserted, the advertisement broadcaster/operator decides one or more factors for inserting the advertisements in the advertisement slots. The one or more factors are considered based on billing amount and business conditions and kinds of advertisements to be played/broadcasted. The one or more factors include, without limitations, kinds of advertisements to be played, duration of each advertisement to be played, time at which the advertisement is to be broadcasted or played. Based on the one or more factors, the placement of advertisements in the advertisement slots is carried out. Information relating to the placement of advertisements in the advertisement slots is provided to the advertisement targeting system 104. The advertisement targeting system 104 broadcasts the advertisements at various advertisement slots of the video stream to the television 106.

FIG. 1b shows a traditional representation of advertisement slots predefined in a video stream. From the illustrated FIG. 1b, the advertisement slots, which are also called cue points, are inserted at various positions of the video stream. Q1, Q2, Q3 and Q4 are the cue points i.e. advertisement slots in the video stream. At each cue point, one or more advertisements are inserted for playing on the electronic device 106. The traditional advertisement system defines the insertion of the advertisement slots at various positions of the video stream, size of the advertisement slots etc. However, in a scenario, considering the user does not wish to watch the advertisements. In such a case, the user either changes the channel and/or does not engage with the advertisements being played. In such a case, playing of the advertisements is wastage of time and power, wastage of network bandwidth used for broadcasting the advertisements.

In one conventional method, linear advertisements are inserted into the advertisement slots. The advertisements are broadcasted to all electronic devices at same time. In such a case, particular kinds of advertisements are broadcasted to the electronic device 106 in order to receive engagement of the user towards the advertisements.

In one conventional method, interactive advertisements are displayed on the electronic device when the user is engaged with the electronic device. The interactive advertisements include, without limitations, banner ads, red button ads, pause point ads, and telescoping ads. The banner ads refer to electronic program guide using which advertisements like microsites, portals are displayed for the user to engage with the advertisements. In red button ads, the user is prompted to press specific remote key at certain intervals to display detailed information of a product shown in the advertisements. In pause point ads, the user pauses or engages with the electronic device e.g. television. Then, an interactive link can be provided to watch a different multimedia content instead of originally played advertisements. In the telescoping ads, a network triggers launch of interactive application pausing the original video content.

In one conventional method, video on demand advertisement is facilitated to the user. In such a way, additional advertisement slots are provided. For example, pre-roll where the advertisements are played before a video starts e.g. before movie starts and post roll where the advertisements are played after movie ends.

However, in all the above conventional methods, the advertisement slots to be inserted are predefined. The objective of the conventional methods is to achieve engagement of the user towards the advertisements being played within the advertisement slots. Particularly, the advertisements are personalized to match user taste and preferences. However, the time at which the advertisements are to be played is not taken into account. In particular, the conventional methods do not consider engagement ability of the user while the advertisement is being played. In such a case, the advertisements are played even if it's inconvenient to the user.

### SUMMARY

A method for managing displaying of multimedia content on an electronic device includes receiving multimedia stream from a broadcasting server by the electronic device. At least one of splice information associated with the multimedia stream or Group of Pictures (GOP) frame sequence of the multimedia stream is identified. Current slot information of the multimedia content to be displayed from the at least one of the splice information or the GOP frame sequence is determined. The current slot information of the multimedia content is modified based on one or more decision parameters associated with the multimedia content. The multimedia content is displayed based on the modified current slot information for managing the displaying of the multimedia content on the electronic device.

An electronic device managing displaying of multimedia content on the electronic device includes a processor and a memory communicatively coupled to the processor. The memory stores processor-executable instructions, which, on execution, cause the processor to receive multimedia stream from a broadcasting server. The processor is configured to identify at least one of splice information associated with the multimedia stream or Group of Pictures (GOP) frame sequence of the multimedia stream. The processor is configured to determine current slot information of the multimedia content to be displayed from the at least one of the splice information or the GOP frame sequence. The processor is configured to modify the current slot information of the multimedia content based on one or more decision parameters associated with the multimedia content. The processor is configured to display the multimedia content based on the modified current slot information for managing the displaying of the multimedia content on the electronic device.

A method for managing broadcasting of multimedia content to an electronic device includes identifying at least one of splice information associated with multimedia stream or Group of Pictures (GOP) frame sequence of the multimedia stream by a broadcasting server. Current slot information of the multimedia content to be broadcasted from the at least one of the splice information or the GOP frame sequence is determined. The current slot information of the multimedia content is modified based on one or more decision parameters associated with the multimedia content. The multimedia content is broadcast based on the modified current slot information to the electronic device for managing the broadcasting of the multimedia content to the electronic device.

A broadcasting server for managing broadcasting of multimedia content to an electronic device includes a processor and a memory communicatively coupled to the processor. The memory stores processor-executable instructions, which, on execution, cause the processor to identify at least one of splice information associated with multimedia stream or Group of Pictures (GOP) frame sequence of the multimedia stream. The processor is configured to determine current slot information of the multimedia content to be broadcasted from the at least one of the splice information or the GOP frame sequence. The processor is configured to modify the current slot information of the multimedia content based on one or more decision parameters associated with the multimedia content. The processor is configured to broadcast the multimedia content based on the modified current slot information to the electronic device for managing the broadcasting of the multimedia content to the electronic device.

A non-transitory computer readable medium for managing displaying of multimedia content on an electronic device is disclosed. The non-transitory computer readable medium includes instructions stored thereon that when processed by a processor causes the electronic device to perform operations comprising receiving multimedia stream from a broadcasting server. At least one of splice information associated with the multimedia stream or Group of Pictures (GOP) frame sequence of the multimedia stream is identified. From the identified at least one of the splice information or the GOP frame sequence, current slot information of the multimedia content to be broadcasted is determined. The determined current slot information of the multimedia content is modified based on one or more decision parameters associated with the multimedia content. The multimedia content is displayed on the electronic device based on the modified current slot information for managing the displaying of the multimedia content on the electronic device.

A non-transitory computer readable medium for managing broadcasting of multimedia content to an electronic device is disclosed. The non-transitory computer readable medium includes instructions stored thereon that when processed by a processor causes a broadcasting server to perform operations comprising identifying at least one of splice information associated with multimedia stream or Group of Pictures (GOP) frame sequence of the multimedia stream. From the at least one of the splice information or the GOP frame sequence, current slot information of the multimedia content to be broadcasted is determined. The current slot information of the multimedia content is modified based on one or more decision parameters associated with the multimedia content. The multimedia content is broadcasted to the electronic device based on the modified current slot information to the electronic device for managing the broadcasting of the multimedia content to the electronic device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates a traditional advertisement system for inserting advertisement slots in multimedia stream;

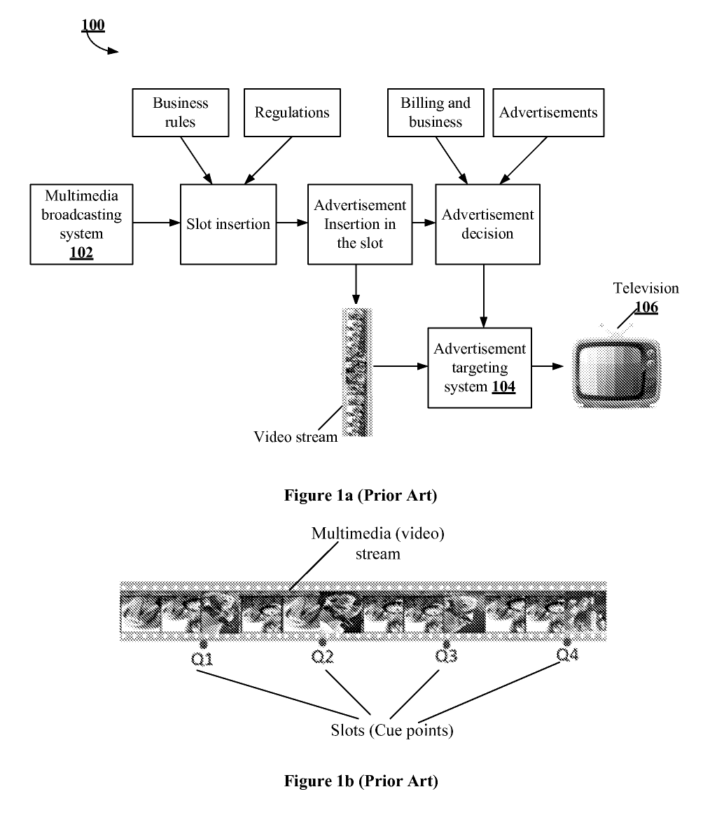

FIG. 1b shows a traditional representation of advertisement slots predefined in multimedia stream i.e. a video stream;

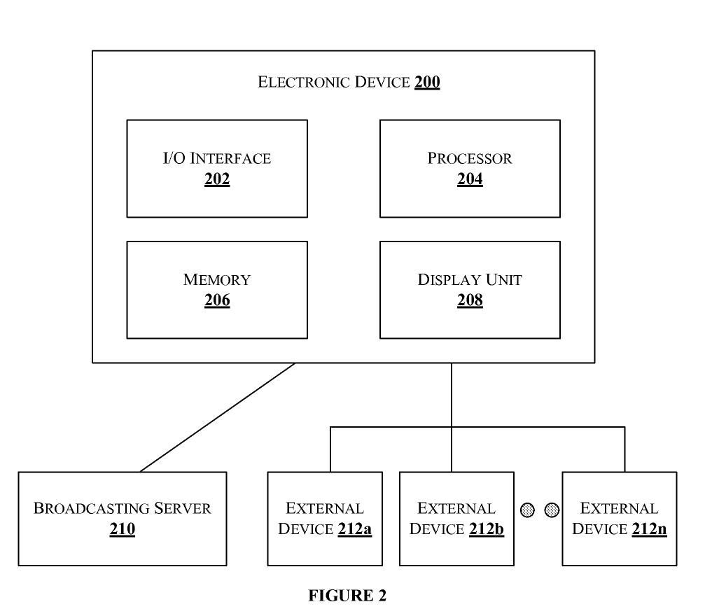

FIG. 2 illustrates a block diagram of an electronic device with an I/O interface, a processor, a memory and a display unit in accordance with some embodiments of the present disclosure;

FIG. 3 illustrates a block diagram of an exemplary electronic device with various data and modules for managing displaying of multimedia content on the electronic device in accordance with some embodiments of the present disclosure;

FIG. 4 shows an example illustrating modification of slots i.e. splice points for displaying multimedia content in accordance with some embodiments of the present disclosure;

FIGS. 5a and 5b show block diagram of an exemplary broadcasting server for managing broadcasting multimedia content to an electronic device in accordance with some embodiments of the present disclosure;

FIG. 6 shows a flowchart illustrating a method for managing displaying of multimedia content on electronic device in accordance with some embodiments of the present disclosure;

FIG. 7 shows a flowchart illustrating a method for managing broadcasting of multimedia content to electronic device in accordance with some embodiments of the present disclosure; and

FIG. 8 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method and an electronic device for managing displaying of multimedia content on the electronic device. Particularly, the embodiments determine desirable time intervals and slots in the video stream for displaying the multimedia content on the electronic device. The electronic device performs the management of the displaying of the multimedia content using the information of the time intervals and slots. The method comprises receiving multimedia stream, for example video stream from a broadcasting server. The broadcasting server broadcasts the multimedia stream and/or the multimedia content. Then, from the multimedia stream, splice information associated with the multimedia stream and/or Group of Pictures (GOP) frame sequences of the multimedia stream are identified. The splice information defines splice points i.e. cue points at which the slots are inserted for placing the multimedia content i.e. ads/advertisements. The slots refer to positions/location in the multimedia stream at which the multimedia content is inserted. The GOP frame sequences includes sequence of Intra coded picture (I frame), Predictive coded picture (P frame) and Bipredictive coded picture (B frame). From the GOP frame sequence, an I frame is identified since the multimedia stream begins from I frame. From one of the splice information and GOP frame sequence, current slot information is determined. The current slot information defines the slots being inserted containing the multimedia content to be broadcasted. The current slot information is modified based on decision parameters associated with the multimedia content. The decision parameters include, without limitations, user parameters, broadcaster parameters, system contextual information, multimedia content contextual information, buffer information of the multimedia content and network parameters of the multimedia content. The user parameters includes, but are not limited to, preferences of users for watching the multimedia content, historical information associated with the multimedia content watched by the user, user category information watching the multimedia stream and/or the multimedia content, subscribing information associated with the multimedia stream and responses of the user towards the multimedia stream. The broadcaster parameters include, but are not limited to, constraints and rules for broadcasting the multimedia content. The broadcaster parameters are dynamically defined by a broadcaster/operator associated with the broadcasting server. The system contextual information includes, but is not limited to, information of environment surrounding a user. The multimedia content contextual information includes, but is not limited to, information based on the multimedia content being watched, type of the multimedia content being watched, and a current multimedia stream being watched by the user. In such a way, the position/placement of the slots are altered so that the multimedia content is played as per the convenience of the user. In such a case, the user can get engaged with the multimedia content. The multimedia content is displayed on the electronic device based on the modified current slot information. The displaying of the multimedia content is managed as per convenience of the user.

Embodiments of the present disclosure disclose a method and a broadcasting server for managing broadcasting of multimedia content to an electronic device. The broadcasting server performs steps similar to the steps performed by the electronic device as described above. However, the broadcasting server broadcasts the multimedia content based on the modified current slot information.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

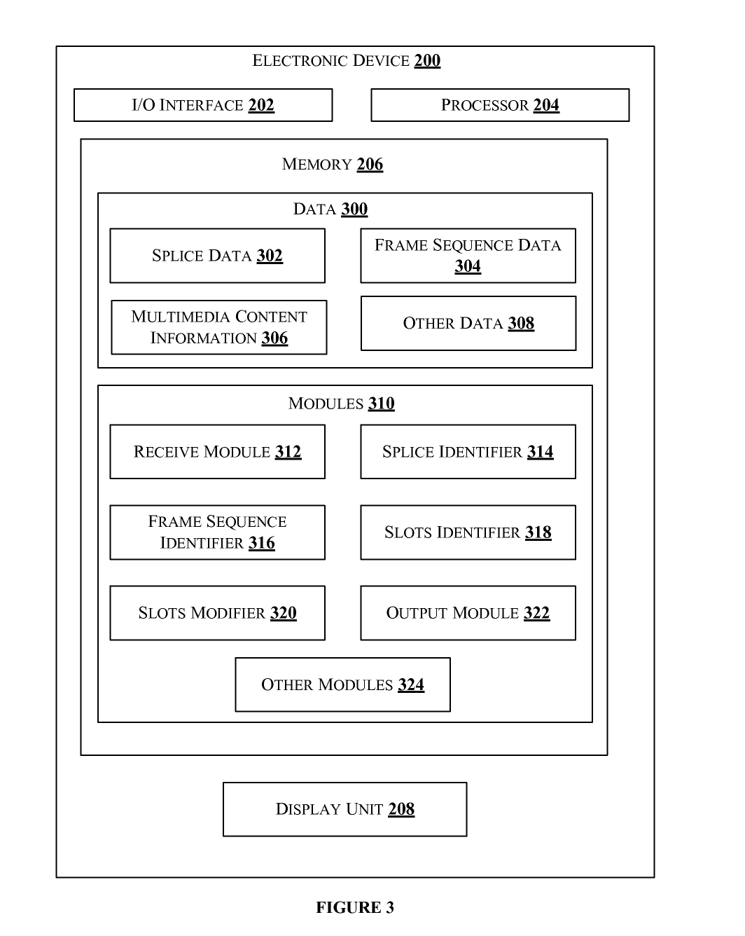

FIG. 2 illustrates a block diagram of an electronic device 200 with an I/O interface 202, a processor 204, a memory 206 and a display unit 208 in accordance with some embodiments of the present disclosure in accordance with some embodiments of the present disclosure.

Examples of the electronic device 200 includes, but is not limited to, mobile phone, ATM machine, Television, digital television, laptop, tablet, desktop computer, Personal Computer (PC), contactless device, and other electronic device capable of playing multimedia stream and/or multimedia content. In an embodiment, the electronic device 200 is communicatively connected to a broadcasting server 210.

In one implementation, the broadcasting sever 210 is configured to broadcast the multimedia stream. Examples of the multimedia streams include, but are not limited to, videos, moving visuals, pictures, films, flicks, movies, cinemas, serials, soaps, shows, images and other entertainment/informative streams. In one implementation, the broadcasting server 210 is associated with one or more channels, particularly program channels. For example, the broadcasting server 210 may be associated to “ABC” program channel on which the multimedia streams are broadcasted. On “ABC” program channel, the broadcasting server 210 broadcasts each multimedia stream of one hour, for example. The broadcasting server 210 can broadcast any multimedia stream for any duration as per predefined by a broadcaster/an operator associated with the broadcasting server 210. In a scenario, consider a multimedia content being broadcasted in between the multimedia stream. The multimedia content includes, but is not limited to, advertisements/ads, commercials, endorsements, promotional videos and other informative content. Each of multimedia content comprises duration of the multimedia content being displayed, buffer size of the multimedia content, and network bandwidth required for displaying the multimedia content. For example, assuming duration of each multimedia content is 20 seconds, buffer size is 128 kilo bytes and bandwidth required for displaying the multimedia content is 2 mega bit per seconds (mbps)

The broadcasting server 210 may be communicatively connected to one or more third party servers (not shown) from which the multimedia content is received by the broadcasting server 210. The broadcasting server 210 is communicatively connected to the one or more third party servers through a first network (not shown). In an embodiment, the broadcasting server 210 is configured to broadcast the multimedia content along with broadcasting of the multimedia stream. For each multimedia stream, one or more slots may be predefined into which the multimedia content is inserted. In one implementation, multiple multimedia contents may be inserted in the one or more slots. For example, three multimedia contents can be inserted in one slot of the multimedia stream. In an embodiment, the one or more slots may be predefined within the multimedia stream, while the multimedia stream is being played and/or before playing the multimedia stream. Each of the one or more slots is inserted at splice points in the multimedia stream. The splice points are also called as cue points which define positions in the multimedia stream at which the one or more slots are inserted, which in turn carries the multimedia content. For example, consider the multimedia stream of 30 minutes. Now, considering the multimedia stream contains three slots i.e. Q1, Q2 and Q3, into which the multimedia content is inserted. Assuming, the three slots i.e. Q1, Q2 and Q3 are inserted in every 10th minute of the multimedia stream. Particularly, the slot Q1 is inserted after 10th minute of the multimedia stream, the slot Q2 is inserted after 20th minute of the multimedia stream and the slot Q3 is inserted after 30th minute of the multimedia stream. Each of the one or more slots is defined with a size required for broadcasting the multimedia content. The size of the slot defines duration of the multimedia content to be displayed. For example, the size of slot Q1 may be predefined to be 2 minutes in the multimedia stream. In an embodiment, the position of the one or more slots i.e. the splice points for inserting the one or more slots and the size of slots are predefined by a broadcaster/an operator associated with the broadcasting server 210. The broadcasting server 210 comprises event specification information which includes information on position of the one or more slots i.e. the splice points for inserting the one or more slots and the size of slots. The event specification information is stored in a Program Management Table (PMT) and the PMT is stored in a Program Specification Information (PSI) configured in the broadcasting server 210. In an embodiment, the kind of the multimedia content to be broadcasted, size of the multimedia content, timestamp of broadcasting the multimedia content and duration of the multimedia content are also stored as event specification information in the PMT in the broadcasting server 210. The broadcasting server 210 provides the information on the position of the one or more slots, the size of slots, the kind of the multimedia content to be broadcasted, the size of the multimedia content, timestamp of broadcasting the multimedia content and the duration of the multimedia content to the electronic device 200 through a communication network. The communication network includes, but is not limited to, satellite, cable and Internet.

The electronic device 200 is associated to one or more external devices 212a, 212b, . . . 212n (collectively referred to as external devices 212). The one or more external devices 212 include, without limitations, sensors (not shown) configured in the electronic device 200, an image capturing device such as camera (not shown) coupled to the electronic device 200, and device based sources 212. The electronic device 200 may be associated with network monitoring tool (not shown). The one or more external devices 212, the network monitoring tool and the broadcasting server 210 provide one or more decision parameters which include, but are not limited to, user parameters, broadcaster parameters, system contextual information, multimedia content contextual information, buffer information and network parameters of the multimedia content. The user parameters and the system contextual information are provided by the sensors and/or the image capturing device.

The broadcaster parameters and the multimedia content contextual information are provided by the broadcasting server 210 (which can be considered as business system/platform). The buffer information and the network parameters of the multimedia content are measured by the network monitoring tool.

The electronic device 200 may include Input/Output (I/O) interface 202, at least one central processing unit (“CPU” or “processor”) 204, memory 206 and display unit 208 for displaying the multimedia content. Particularly, the electronic device 200 modifies time intervals for displaying the multimedia content and/or position of the one or more slots (i.e. alters the splice points) in the multimedia stream for managing the displaying of the multimedia content.

The I/O interface 202 is a medium through which the multimedia stream and the multimedia content are received from the broadcasting server 210. In an embodiment, the multimedia content can be received from the one or more third party servers by the electronic device 200 through the I/O interface 202. The I/O interface 202 is configured to receive information on the position of the one or more slots, the size of slots, the kind of the multimedia content to be broadcasted, the size of the multimedia content, timestamp for broadcasting the multimedia content and the duration of the multimedia content. The I/O interface 202 is configured to receive the one or more decision parameters associated with the multimedia content from the one or more external devices 212, the network monitoring tool and the broadcasting server 210. The I/O interface 202 is configured to provide the multimedia content for displaying based on the modified time intervals and/or the position of the one or more slots which depends on the one or more decision parameters. In an embodiment, the I/O interface 202 is coupled with the processor 204.

The processor 204 may comprise at least one data processor for executing program components for executing user- or device-generated operations for managing displaying of the multimedia content. The processor 204 is configured to identify splice information related to the splice points of the multimedia stream based on the event specification information i.e. PSI associated with the multimedia stream. The processor 204 is configured to identify kind of frame of the multimedia stream for identifying Group of Pictures (GOP) frame sequence of the multimedia stream. In an embodiment, the processor 204 determines current slot information related to the position of the one or more slots and the size of slots from the splice information and the GOP frame sequence. The processor 204 modifies the current slot information of the multimedia content i.e. modifies the time intervals and/or position of the one or more slots based on the one or more decision parameters associated with the multimedia content. The processor 204 is configured to modify the size of slots in the multimedia stream and the buffer size of the multimedia content to alter the buffering capacity of the multimedia content. The processor 204 increases and/or decreases number of the one or more slots i.e. number of splice points. The processor 204 displays the multimedia content based on the modified current slot information which is related to the modified time interval for displaying the multimedia content and/or the position of the one or more slots. In such a way, the displaying of the multimedia content on the electronic device 200 is managed. The management of the displaying of the multimedia content on the electronic device 200 is performed by various modules which are explained in following description. The various modules are executed by the processor 204 of the electronic device 200.

The memory 206 stores instructions which are executable by the at least one processor 104. The memory 206 stores multimedia stream data including a splice data related to the splice information, a frame sequence data related to the GOP frame sequence, and multimedia content information. In an embodiment, the multimedia stream data including the splice data, the frame sequence data, the multimedia content information are stored as one or more data required for managing the displaying of the multimedia content on the electronic device 200. The one or more data are described in the following description of the disclosure.

The display unit 208 displays the multimedia stream and the multimedia content. In an embodiment, the display unit 208 displays the multimedia content based on the modified current slot information. In such a way, the displaying of the multimedia content is managed based on conveniences of a user in order to target engagement of the user towards the multimedia content.

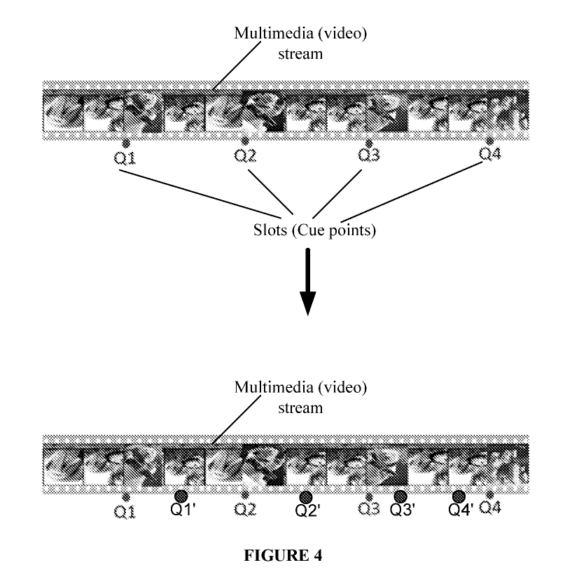

FIG. 3 illustrates a block diagram of the exemplary electronic device 200 with various data and modules for managing displaying of the multimedia content on the electronic device 200 in accordance with some embodiments of the present disclosure. In the illustrated FIG. 3, the one or more data 300 and the one or more modules 210 stored in the memory 206 are described herein in detail.

In an embodiment, the one or more data 300 may include, for example, the splice data 302, the frame sequence data 304, the multimedia content information 306 and other data 308 for managing the displaying of the multimedia content on the display unit 208 of the electronic device 200.

The splice data 302 refers to information of the splice points i.e. the cue points of the multimedia stream. The splice data 302 comprises position of each of the splice points i.e. the cue points in the multimedia stream. The splice data 302 also comprises number of splice points i.e. number of cue points in the multimedia stream, which depends on the size of the multimedia stream. At splice points, one or more slots are inserted where each slot comprises a particular size. For example, 30 minutes of multimedia stream may contain four slots at four splice points respectively. Each slot is predefined to be 128 kilo bytes. In an embodiment, the splice data 302 of the multimedia stream is identified from the PSI contained in the broadcasting server 210.

The frame sequence data 304 refers to the GOP frame sequence. The GOP frame sequence is identified upon determining the kinds of frame of the multimedia stream. The kinds of frame includes, without limitation, Intra coded picture (I) frame, Predictive coded picture (P) frame and Bipredictive coded picture (B). The GOP frame sequence is a sequence of I, P and B frames in the multimedia stream. The displaying of the multimedia stream in initiated from every I frame. Therefore, I frames of the multimedia stream are identified as the splice points i.e. cue points are identified at every I frame. The GOP frame sequence depends on the size of the multimedia stream.

The multimedia content information 306 refers to the kind of the multimedia content to be displayed, size of the multimedia content, timestamp for broadcasting the multimedia content and duration of the multimedia content to be displayed. For example, the kind of the multimedia content can be sports specific advertisements, or female/male oriented ads, children specific ads etc. The size of the multimedia content refers to resolution of the multimedia content for example 1080p, 720p etc. The timestamp for displaying refers to the time in the multimedia stream, for example, 10th minute of the multimedia stream refers to the timestamp for displaying the multimedia content. The duration of the multimedia content refers to period for which the multimedia content is to be displayed. For example, duration may be defined as 2 minutes for which the advertisements may be displayed. The multimedia content information 306 also includes network parameters and buffer size of the multimedia content. The network parameters includes network bandwidth conditions required for displaying the multimedia content and the buffer size refers to fullness of the buffer of the multimedia content. The fullness of the buffer size refers to amount of the multimedia content buffered for displaying. For example, a video stream of a particular size and time taken to buffer the particular size/capacity while downloading for displaying refers to the fullness of the buffer size. Considering, a cue point is identified at 3 seconds from current time. The current video buffer fullness expected for next 3 seconds is determined. Then, based on network condition and video playback condition the request to provide 3 seconds of buffering is accomplished.

The other data 308 may refer to such data which can be associated to the multimedia stream and/or the multimedia content for managing the displaying of the multimedia content on the electronic device 200.

In an embodiment, the one or more data 300 in the memory 206 are processed by the one or more modules 310 of the electronic device 200. The one or more modules 310 may be stored within the memory 206 as shown in FIG. 3. In an example, the one or more modules 310, communicatively coupled to the processor 204, may also be present outside the memory 206 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 310 may include, for example, a receive module 312, a splice identifier 314, a frame sequence identifier 316, a slots identifier 318, a slots modifier 320, and an output module 322. The memory 206 may also comprise other modules 324 to perform various miscellaneous functionalities of the electronic device 200. It will be appreciated that such aforementioned modules may be represented as a single module or a combination of different modules.

In an embodiment, the receive module 312 receives the multimedia stream and the multimedia content from the broadcasting server 210 through the I/O interface 202. For example, the receive module 312 receives a video stream required to be displayed for 30 minutes.

The splice identifier 314 parses the event specific information in the PMT to identify the splice points of the multimedia stream. The splice points are identified using the splice data 302. By identifying the splice points, the positions of the one or more slots are identified corresponding to the splice points. The splice identifier 314 identifies the size of each of the splice points, timestamp of each of the splice points and duration of each of the splice points. From the splice point identification, the positions, the size and duration of the one or more slots are identified by the splice identifier 314. For example, consider a video stream of 30 minutes. Assuming, the video stream comprises four splice points. In an embodiment, number of splice points corresponds to number of the slots to be inserted in the multimedia stream. Therefore, from the splice points, splice identifier 314 identifies that there are four slots i.e. Q1, Q2, Q3 and Q4 in the video stream. Consider, the slot Q1 is 1 mega bytes and 30 seconds inserted at time T1 of the video stream. Similarly, slot Q2 is 2 mega bytes and 60 seconds inserted at time T2 of the video stream, slot Q3 is 1 mega bytes and 15 seconds inserted at time T3 of the video stream and slot Q4 is 1.5 mega bytes and 45 seconds inserted at time T4 of the video stream. In an embodiment, if splice information relating to the splice points is not available, then occurrence of drastic timestamp changes in short bursts like 30 seconds (s), 60 s and 90 s etc. are considered to be the splice points. In an embodiment, every video frame is incrementally time stamped. When a jump in the time stamp occurs, then it means that a different video is being played. The point and time at which the jump occurs is considered to be the splice point.

The frame sequence identifier 316 identifies the GOP frame sequence from the sequence of I, P and B frames. From GOP frame sequence, the next I frame in the multimedia stream at which the one or more slots are inserted are identified by the frame sequence identifier 316.

The slots identifier 318 determines the current slot information of each of the one or more slots from the splice data 302 and/or from the frame sequence data 304. Particularly, the current slot information is determined based on splice information provided by the splice identifier 314 and/or the GOP frame sequence provided by the frame sequence identifier 316. For example, the current slots identifier 318 determines that the four splice points are present in the video stream. The current slots identifier 318 determines that the size and duration of each of the one or more slots inserted at corresponding splice points. Particularly, the current slot identifier 318 determines that the slots Q1, Q2, Q3 and Q4 comprise size 1 mega bytes, 2 mega bytes, 1 mega bytes and 1.5 mega bytes with duration 30 seconds, 60 seconds, 15 seconds and 45 seconds respectively. The current slot information comprises the timestamp and duration of the multimedia content. The multimedia content displayed during the slot depends on the duration of the multimedia content and the duration of the slots. If the duration of the multimedia content is greater than the duration of the slot, the multimedia content cannot be displayed. In an embodiment, the current slot information along with its duration and timestamp information are stored in the memory 206. The duration for displaying the multimedia content is not altered. For example, consider initially the duration for displaying the multimedia content is predefined to be 16 minutes in a one hour period. Then, multimedia content can be displayed for 16 minutes duration during that one hour period. In a scenario, the multimedia content can be displayed for less than 16 minutes and/or can be displayed for more than 16 minutes. If the multimedia content is displayed for less than 16 minutes, then black outs are displayed for the remaining period. In case the multimedia content duration is longer than the slot duration, then P and B frames are dropped such that the multimedia content is displayed for the duration of the slot. Even after dropping all the P and B frames, if the multimedia content duration is greater, then one of the two approaches is performed. First approach is to drop and eliminate the displaying of the remaining multimedia content. Second approach is to drop the P and B frames for the multimedia content displayed for managing the extra duration of the multimedia content. If for any slot, the duration of the slot is changed, then packet drops and/or block out spots in the slot is managed with respect to maintaining the duration of the slot. For example, black outs of the one or more slots due to displaying of the multimedia content of less duration as compared to the predefined duration is eliminated. Similarly, drop outs of packets of the multimedia contents out of the one or more slots due to greater duration of the multimedia content are eliminated. Additionally, in such a case, the multimedia content is configured to be repeatedly displayed or dropped in/from the one or more slots.

The slots modifier 320 modifies the current slot information identified by the current slot identifier 318 based on the one or more decision parameters associated with the multimedia content. The modification of the current slot information is related to increasing and/or decreasing size and duration of the one or more slots, increasing and/or decreasing buffer size and duration of the multimedia content, timestamp for displaying the multimedia content, position of the one or more slots. The one or more decision parameters include, but are not limited to, the user parameters, the broadcaster parameters, the system contextual information, the multimedia content contextual information, the buffer information of the multimedia content and the network parameters of the multimedia content.

The user parameters are received from the sensors and the image capturing device such as the camera. The user parameters include, without limitation, preferences of user/s for watching the multimedia content, user emotions, user state of mind, historical information associated with the multimedia content watched by the user, user category information watching at least one of the multimedia stream or the multimedia content, subscribing information associated with the multimedia stream and responses of the user towards the multimedia stream. The preferences of users refer to kinds of the multimedia content, number of times and duration for which the user wishes to watch the multimedia content. The historical information associated with the multimedia content refers to the multimedia content already been watched by the users in past. The user category refers to gender information of each users, age of each user, and interest parameters of each user to watch the multimedia content. The subscribing information refers to kinds of subscribers towards the multimedia stream. For example, for premium user subscriber, the number of ads to be displayed may be less. The responses of the users towards the multimedia stream refer to user emotions while watching the multimedia stream and/or the multimedia content. For example, the response having the user emotions include, without limitation, happiness emotion of users, anger, sad, frustration factor of the users while watching particular scene in the video stream or while watching the ads. The user emotions are identified based on actions performed by the users, for example, changing of channel, facial expressions of the user while watching the multimedia stream/multimedia content, actions involving using the remote to reduce the volume etc.

The broadcaster parameters are received from the broadcaster and/or the operator associated with the broadcasting server 210. The broadcaster parameters include, without limitation, one or more constraints and one or more rules predefined for broadcasting the multimedia content. The one or more constraints includes, without limitations, time to display the multimedia content, type of multimedia contents to be displayed etc. For example, the broadcaster and/or the operator may specify the advertisement to be of 3 minutes long at a given time T1, the advertisement must be displayed at time T2, the advertisement must be displayed at every 10th minutes of the multimedia stream, addition of the multimedia content ‘X’ to a list of the multimedia contents to be displayed etc. The one or more rules refer to business rules, advertisement policies, subscribing details of the channel, subscribing information of the multimedia content to be displayed and the like. For example, sports specific advertisements are subscribed for a channel, advertisement policies like to show the ad only for once in a day etc.

The system contextual information is received from the sensors and the image capturing device such as camera. The sensors include, without limitations, thermostat, gyroscope, skin emotion detector from remote control. The system contextual information includes, without limitation, information of environment surrounding users. For example, environment refers to temperature level around the electronic device 200, sound levels being played while watching the multimedia content. The environment refers to day timing information for example in day time the kind of the multimedia stream and/or the multimedia content being watched by the user. For example, the day timing refers morning time, afternoon time evening time during which the multimedia stream is watched. The system contextual information also refers to the kind of electronic device 200 on which the multimedia content is being watched.

The multimedia content contextual information is received from the sensors such as thermostat, gyroscope, skin emotion detectors via remote control 212, the broadcasting server 210 and the image capturing device such as the camera 212. The multimedia content contextual information includes, without limitation, information of the multimedia content being watched, and type of the multimedia content being watched. For example, a cookery shows watched by the users refers to the type and interest of the multimedia content being watched. The multimedia content contextual information includes current multimedia stream which refers to current scene being watched by the user.

The buffer information of the multimedia content and the network parameters of the multimedia content are received by the network bandwidth and buffer measuring device. The network parameters refer to network conditions required for displaying the multimedia content. The buffer information refers to the fullness of the buffer size of the multimedia content required to be downloaded and displayed along with displaying of the multimedia stream. For example, consider the slot Q2 requires network bandwidth of 5 mbps with buffer size of 3 megabytes. Then, based on the network bandwidth of 5 mbps with the buffer size of 3 megabytes, the current slot information is modified i.e. placement or position of the slot Q1 is modified.

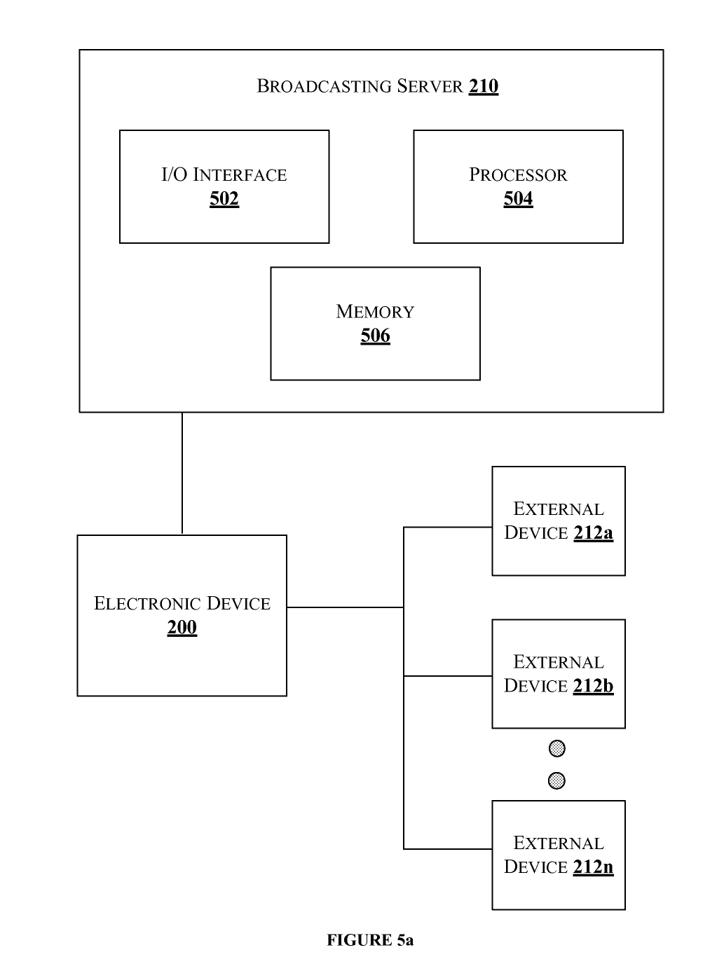

In an embodiment, based on the one or more decision parameters, duration and size of the multimedia content and/or the one or more slots, position/placement of the one or more slots i.e. the splice points are modified. FIG. 4 shows the current slot information based on the one or more decision parameters. For example, consider four slots Q1, Q2, Q3 and Q4 positioned at every 10th minute of the multimedia stream. Based on the one or more decision parameters, the slot Q1 is shifted to different position of the splice point depicted by slot Q1′ whereby the displaying of the multimedia content is delayed. Similarly, the slots Q2 and Q3 are shifted to different positions of the splice points depicted by slot Q2′ and Q3′. But, based on the one or more decision parameters, assuming that the user wishes to watch the multimedia content before the multimedia content displays at slot Q4. Therefore, the slot Q4 is shifted to a different position before the original position of the slot Q4. The new position of the slot Q4 is depicted by Q4′ which is before the position of the original slot Q4.

Referring back to FIG. 3, the output module 322 displays the multimedia content based on the modified current slot information on the display unit 208. In such a way, the displaying of the multimedia content is managed based on the convenience of the users.

The other modules 324 processes all such operations required to manage the displaying of the multimedia content on the display unit 208 of the electronic device 200.

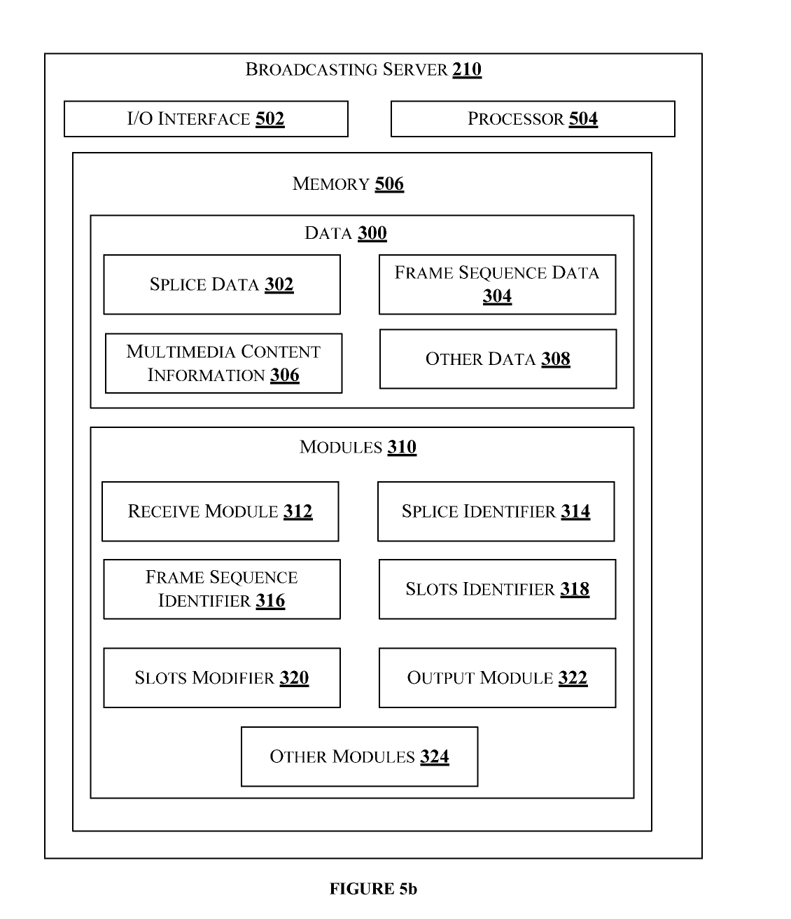

FIGS. 5a and 5b show a block diagram of an exemplary broadcasting server 500 having processor, memory, data and various modules for managing broadcasting of the multimedia content to the electronic device 200. From the illustrated FIG. 5a, the broadcasting server 210 comprises I/O interface 502, a processor 504, and memory 504. From the illustrated FIG. 5b, the broadcasting server 210 comprises various data 300 and various modules 310 for managing broadcasting of the multimedia content to the electronic device 200. The broadcasting server 210 performs various steps and functions similar to the modules 310 of the electronic device 200. The broadcasting server 210 receives the one or more decision parameters over the communication network from the one or more external devices 212 associated to the electronic device 200. The broadcasting server 500 broadcasts the multimedia content based on the modified current slot information to the electronic device 200.

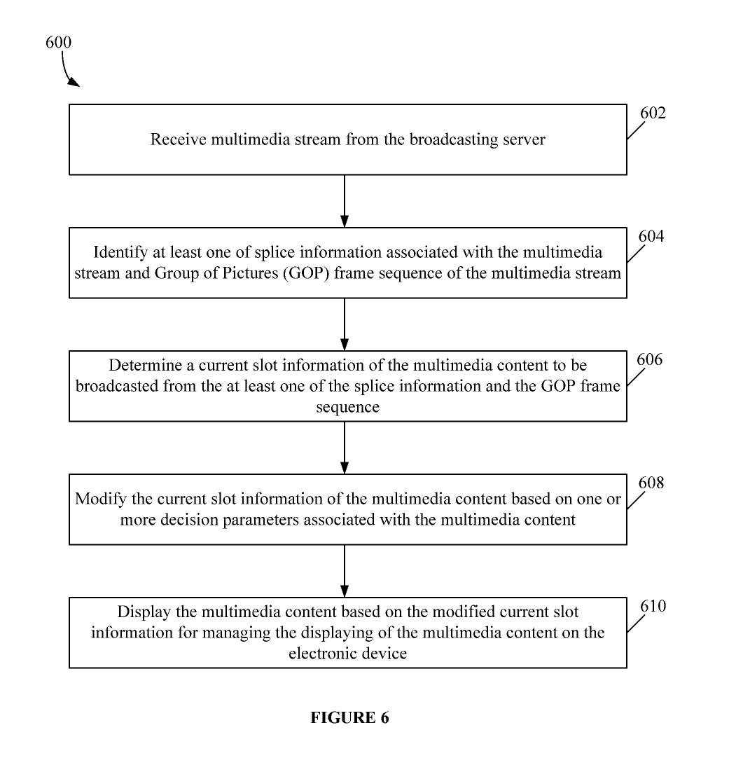

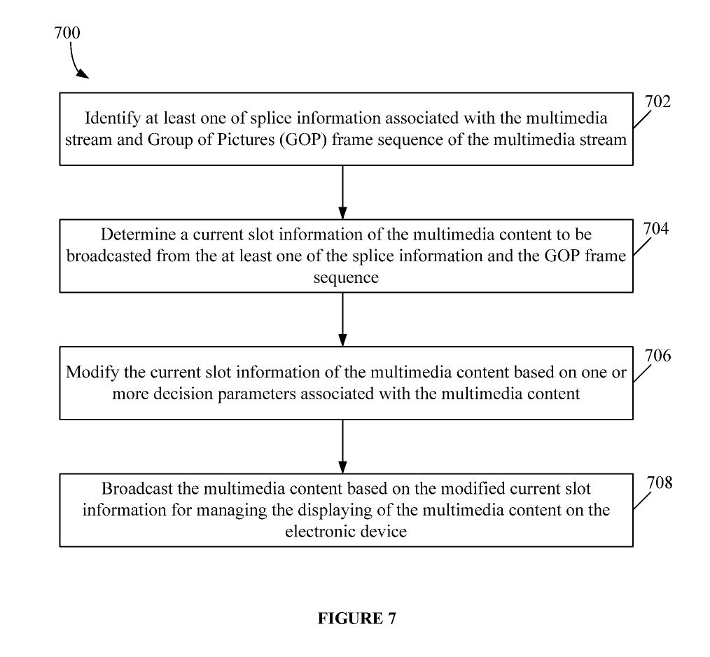

As illustrated in FIGS. 6 and 7, the method comprises one or more blocks for managing displaying and/or broadcasting of the multimedia content. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

FIG. 6 shows a flowchart illustrating a method for managing displaying of multimedia content on the electronic device 200 in accordance with some embodiments of the present disclosure.

At block 602, the electronic device 200 receives the multimedia stream from a broadcasting server 210.

At block 604, the splice information associated with the multimedia stream and/or the Group of Pictures (GOP) frame sequence of the multimedia stream are identified. The splice information associated with the multimedia stream of the multimedia stream is performed based on event specific information i.e. PSI associated with the multimedia stream. If PSI information is not available then the GOP frame sequence is identified by identifying frames to be one of I, P and B frame. From the sequence of I, P and B frames, the GOP frame sequence is identified.

At block 606, current slot information of the multimedia content to be broadcasted is determined from the at least one of the splice information or the GOP frame sequence. In an embodiment, the current slot information comprises duration of the multimedia content and timestamp of displaying the multimedia content.

At block 608, the current slot information of the multimedia content is modified based on one or more decision parameters associated with the multimedia content. In an embodiment, the one or more decision parameters comprises the user parameters, the broadcaster parameters, the system contextual information, the multimedia content contextual information, the buffer information of the multimedia content and the network parameters of the multimedia content. In an embodiment, the user parameters includes, without limitation, preferences of user/s for watching the multimedia content, historical information associated with the multimedia content watched by the user, user category information watching at least one of the multimedia stream or the multimedia content, subscribing information associated with the multimedia stream and responses of the user towards the multimedia stream. The broadcaster parameters include, without limitation, the one or more constraints and one or more rules predefined for broadcasting the multimedia content. The system contextual information comprises information of environment surrounding the user. The multimedia content contextual information includes, without limitation, the information based on the multimedia content being watched, type of the multimedia content being watched, and a current multimedia stream being watched by the user.

At block 610, the multimedia content is displayed on the display unit 208 of the electronic device 200 based on the modified current slot information for managing the displaying of the multimedia content on the electronic device 200.

FIG. 7 shows a flowchart illustrating a method for managing broadcasting of multimedia content to electronic device in accordance with some embodiments of the present disclosure.

At block 702, the broadcasting server 210 identifies the splice information associated with the multimedia stream and/or the Group of Pictures (GOP) frame sequence of the multimedia stream. The splice information associated with the multimedia stream of the multimedia stream is performed based on event specific information i.e. PSI associated with the multimedia stream. If PSI information is not available then the GOP frame sequence is identified by identifying frames to be one of I, P and B frame. From the sequence of I, P and B frames, the GOP frame sequence is identified.

At block 704, current slot information of the multimedia content to be broadcasted is determined from the at least one of the splice information or the GOP frame sequence. In an embodiment, the current slot information comprises duration of the multimedia content and timestamp of displaying the multimedia content.

At block 706, the current slot information of the multimedia content is modified based on one or more decision parameters associated with the multimedia content. In an embodiment, the one or more decision parameters comprises the user parameters, the broadcaster parameters, the system contextual information, the multimedia content contextual information, the buffer information of the multimedia content and the network parameters of the multimedia content. In an embodiment, the user parameters includes, without limitation, preferences of user/s for watching the multimedia content, historical information associated with the multimedia content watched by the user, user category information watching at least one of the multimedia stream or the multimedia content, subscribing information associated with the multimedia stream and responses of the user towards the multimedia stream. The broadcaster parameters include, without limitation, the one or more constraints and one or more rules predefined for broadcasting the multimedia content. The system contextual information comprises information of environment surrounding the user. The multimedia content contextual information includes, without limitation, the information based on the multimedia content being watched, type of the multimedia content being watched, and a current multimedia stream being watched by the user. The one or more decision parameters are received over the network from the one or more external device associated to the electronic device 200.

At block 708, the multimedia content is broadcasted by the broadcasting server 210 to the display unit 208 of the electronic device 200 based on the modified current slot information for managing the displaying of the multimedia content on the electronic device 200.

### Computer System

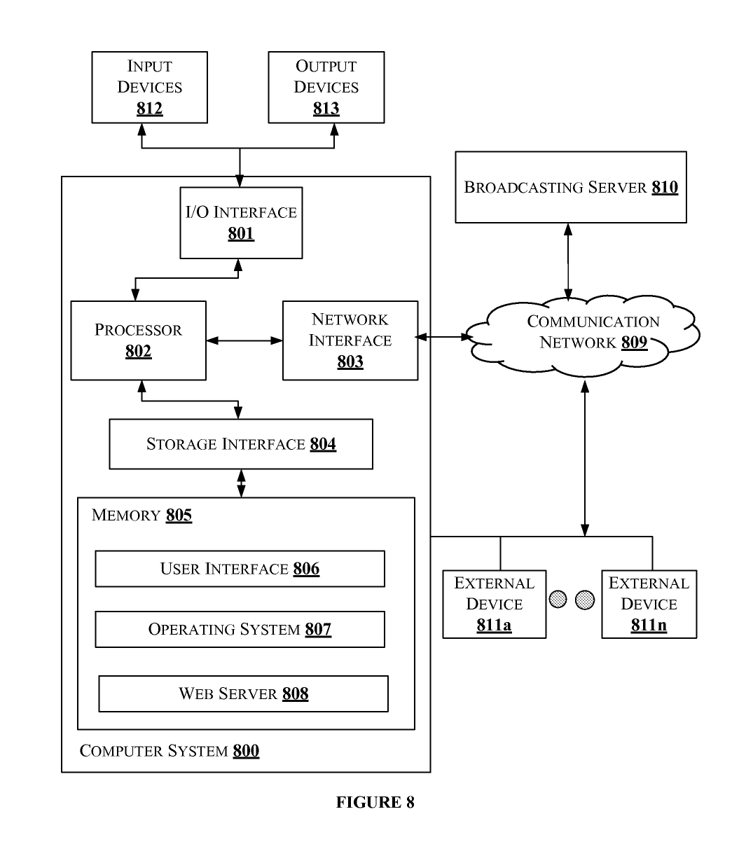

FIG. 8 illustrates a block diagram of an exemplary computer system 800 for implementing embodiments consistent with the present disclosure. In an embodiment, the computer system 800 is used to implement the electronic device 200 and the broadcasting server 210. The computer system 800 manages the displaying of the multimedia content on the electronic device 200 when configured as the electronic device 200. The computer system 800 manages the broadcasting of the multimedia content to the electronic device 200 when configured as the broadcasting server 210. The computer system 800 may comprise a central processing unit (“CPU” or “processor”) 802. The processor 802 may comprise at least one data processor for executing program components for executing user- or device-generated multimedia content. The processor 802 may include specialized processing units such as integrated system (bus) controllers, memory management control units, floating point units, graphics processing units, digital signal processing units, etc.

The processor 802 may be disposed in communication with one or more input/output (I/O) devices (not shown) via I/O interface 801. The I/O interface 801 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 801, the computer system 800 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processor 802 may be disposed in communication with a communication network 809 via a network interface 803. The network interface 803 may communicate with the communication network 809. The network interface 803 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 809 may include, without limitation, a direct interconnection, local area network (LAN), wide area network (WAN), wireless network (e.g., using Wireless Application Protocol), the Internet, etc. Using the network interface 803 and the communication network 809, the computer system 800 may communicate with the broadcasting server 810. The network interface 803 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 809 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 802 may be disposed in communication with a memory 805 (e.g., RAM, ROM, etc. not shown in FIG. 8) via a storage interface 804. The storage interface 804 may connect to memory 805 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 805 may store a collection of program or database components, including, without limitation, user interface 806, an operating system 807, web server 808 etc. In some embodiments, computer system 800 may store user/application data 806, such as the data, variables, records, etc. as described in this disclosure. Such databases may be implemented as fault-tolerant, relational, scalable, secure databases such as Oracle or Sybase.

The operating system 807 may facilitate resource management and operation of the computer system 800. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 800 may implement a web browser 807 stored program component. The web browser 808 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 808 may utilize facilities such as AJAX, DHTML, Adobe Flash, JavaScript, Java, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 600 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present invention are related to alter the positions and time interval for broadcasting and displaying of the advertisement. In such a way, the advertisements are broadcasted and displayed as per user convenience. In such a case, engagement of the user is accomplished.

Embodiments of the present invention reduce wastage of time and network usage for broadcasting and displaying the advertisement which users are not watching. This is because the ads are broadcasted and displayed as per user convenience.

Embodiments of the present invention pertain to time to specify when to display the advertisements. Advantage is to display the advertisement as per convenient of the user despite of wasting time when user is really not interested to watch the advertisement.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor or a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 6 and 7 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for managing displaying of multimedia content, the method comprising:
receiving, by an electronic device, a multimedia stream from a broadcasting server;
identifying, by the electronic device, at least one of splice information associated with the multimedia stream or a Group of Pictures (GOP) frame sequence of the multimedia stream;
determining, by the electronic device, a current slot information of the multimedia content to be displayed from the at least one of the splice information or the GOP frame sequence;
modifying, by the electronic device, the current slot information of the multimedia content based on one or more decision parameters associated with the multimedia content; and
displaying, by the electronic device, the multimedia content based on the modified current slot information for managing the displaying of the multimedia content on the electronic device.

2. The method of claim 1, wherein the identifying the splice information associated with the multimedia stream of the multimedia stream is performed based on event specific information associated with the multimedia stream.

3. The method of claim 1, wherein the GOP frame sequence comprises sequences of Intra (I) frame, Predictive (P) frame and Bipredictive (B) frame.

4. The method of claim 1, wherein the current slot information comprises at least one of duration of the multimedia content or timestamp of displaying the multimedia content.

5. The method of claim 1, wherein the one or more decision parameters comprises at least one of user parameters, broadcaster parameters, system contextual information, multimedia content contextual information, buffer information of the multimedia content or network parameters of the multimedia content.

6. The method of claim 5, wherein the user parameters comprise at least one of preferences of users for watching the multimedia content, historical information associated with the multimedia content watched by the user, user category information watching at least one of the multimedia stream or the multimedia content, subscribing information associated with the multimedia stream or responses of the user towards the multimedia stream.

7. The method of claim 5, wherein the broadcaster parameters comprise at least one of one or more constraints or one or more rules predefined for broadcasting the multimedia content.

8. The method of claim 5, wherein the system contextual information comprises information of environment surrounding a user.

9. The method of claim 5, where in the multimedia content contextual information comprises at least one of information based on the multimedia content being watched, type of the multimedia content being watched, or a current multimedia stream being watched by the user.

10. An electronic device for managing displaying multimedia content on the electronic device, comprising:
a processor;
a memory communicatively coupled to the processor, wherein the memory stores processor-executable instructions, which, on execution, cause the processor to:
receive multimedia stream from a broadcasting server;
identify at least one of splice information associated with the multimedia stream or Group of Pictures (GOP) frame sequence of the multimedia stream;
determine a current slot information of the multimedia content to be displayed from the at least one of the splice information or the GOP frame sequence;
modify the current slot information of the multimedia content based on one or more decision parameters associated with the multimedia content; and
display the multimedia content based on the modified current slot information for managing the displaying of the multimedia content on the electronic device.

11. The electronic device of claim 10, wherein the memory stores the splice information and the GOP frames sequence.

12. A method for managing broadcasting of multimedia content to an electronic device, the method comprising:
identifying, by a broadcasting server, at least one of splice information associated with multimedia stream or Group of Pictures (GOP) frame sequence of the multimedia stream;
determining, by the broadcasting sever, a current slot information of the multimedia content to be broadcasted from the at least one of the splice information or the GOP frame sequence;
modifying, by the broadcasting server, the current slot information of the multimedia content based on one or more decision parameters associated with the multimedia content; and
broadcasting, by the broadcasting sever, the multimedia content based on the modified current slot information to the electronic device for managing the broadcasting of the multimedia content to the electronic device.

13. The method of claim 12, wherein the identifying the splice information associated with the multimedia stream is performed based on event specific information associated with the multimedia stream.

14. The method of claim 12, wherein the current slot information comprises at least one of duration of the multimedia content or timestamp of broadcasting the multimedia content.

15. The method of claim 12, wherein the one or more decision parameters comprises at least one of user parameters, broadcaster parameters, system contextual information, multimedia content contextual information, buffer information of the multimedia content or network parameters of the multimedia content.

16. The method of claim 15, wherein the user parameters comprise at least one of preferences of users for watching the multimedia content, historical information associated with the multimedia content watched by the user, user category information watching at least one of the multimedia stream or the multimedia content, subscribing information associated with the multimedia stream or responses of the user towards the multimedia stream.

17. A non-transitory computer readable medium including instructions stored thereon that when processed by a processor cause an electronic device to perform acts comprising:
receiving multimedia stream from a broadcasting server;
identifying at least one of splice information associated with the multimedia stream or Group of Pictures (GOP) frame sequence of the multimedia stream;
determining a current slot information of the multimedia content to be broadcasted from the at least one of the splice information or the GOP frame sequence;
modifying the current slot information of the multimedia content based on one or more decision parameters associated with the multimedia content; and
displaying the multimedia content based on the modified current slot information for managing the displaying of the multimedia content on the electronic device.
